(19) United States
(12) Patent Application Publication
(10) Pub. No.: US 2016/0124936 A1
(43) Pub. Date: May 5, 2016

(54) GRAMMAR COMPILING METHODS, SEMANTIC PARSING METHODS, DEVICES, COMPUTER STORAGE MEDIA, AND APPARATUSES

(71) Applicant: BAIDU ONLINE NETWORK TECHNOLOGY (BEIJING) CO., LTD., Beijing (CN)

(72) Inventors: Yujun Wang, Beijing (CN); Lei Jia, Beijing (CN); Guanglu Wan, Beijing (CN); Zhengxiang Jiang, Beijing (CN)

(21) Appl. No.: 14/892,818

(22) PCT Filed: May 28, 2014
(86) PCT No.: PCT/CN2014/078596

§ 371 Date: Nov. 20, 2015

(30) Foreign Application Priority Data
May 28, 2013 (CN) 201310203987.2

(51) Int. Cl. G06F 17/27

(52) U.S. Cl. CPC G06F 17/274; G06F 17/271; G06F 17/2785

(57) ABSTRACT

A corresponding grammar description file and a word category description file are defined based on a logical grammar by manifest language LGML according to a common sentence expression of a semantic meaning, in the grammar description file, the description for a common sentence is composed by operators, word categories, and functions, the word category description file is used to describe specific values for the word categories; the grammar description file and the word category description file are generated, with a reduction method according to a defined sequence, into a grammar tree for the grammar description file and word category trees for the word category description file; the word category trees are grafted at the positions of corresponding word categories on the grammar tree, forming a grammar tree for the semantic meaning, in this way, grammar compiling is accomplished. Based on the grammar tree of a semantic meaning with aforementioned ways, semantic parsing is carried out with whole-sentence matching, semantic mapping matching, or a combination of whole-sentence matching and semantic mapping matching.

This application claims the priority of the Chinese patent application filed on May 28, 2013 with the application No. 201310203987.2 and the title “Grammar compiling methods, semantic parsing methods and corresponding devices”.

### TECHNICAL FIELD

The present disclosure relates to the field of computer technology, in particular to grammar compiling methods, semantic parsing methods, devices, computer storage media and apparatuses.

### BACKGROUND

Speech recognition and semantic parsing of spoken language are two important techniques for speech interaction products. Speech recognition is to convert speech into words. Semantic parsing of spoken language is to understand information carried by voices from spoken language. The accuracy of speech recognition and semantic parsing of spoken language has direct effect on user experiences. The main technique adopted to improve the accuracy of speech recognition and semantic parsing of spoken language is two context-free grammar protocols by W3C (World Wide Web Consortium) to build recognition space, namely, using the grammar in the form of BNF or grammar based on XML (Extensible Markup Language).

People talk with natural spoken language, behavior and wording of which are typically significantly different from text input. For example, the spoken language may be characterized by loose grammar and inverse word order. The BNF grammar recommended by W3C or grammar of XML format are used by mainstream large vocabulary continuous speech recognition devices. Nevertheless, because of the deep parsing level of BNF and XML, semantic mapping and syntactic understanding using these two grammars are extremely complicated, with poor readability and maintainability and it is difficult to do relevant grammar compiling and semantic parsing.

### SUMMARY

In view of this, the present disclosure provides embodiments of methods for grammar compiling, methods for semantic parsing and corresponding devices, so as to facilitate readability and maintainability.

In an embodiment, a grammar compiling method defines (or pre-defines) a corresponding grammar description file and a corresponding word category description file based on a logical grammar by manifest language LGML according to a common sentence expression of a semantic meaning, in the grammar description file, the description for a common sentence is composed by operators, word categories, and functions, the word category description file is used to describe specific values for the word categories;
the grammar description file and the word category description file are respectively generated, with a reduction method according to a defined sequence (which may be pre-defined), into a grammar tree for the grammar description file and word category trees for the word category description file;
the word category trees are grafted at the positions of corresponding word categories on the grammar tree, forming a grammar tree for the semantic meaning.

According to an embodiment, the word category description file comprises word items, or comprises, besides word items, at least one of the operators and functions to describe relationships between word items.

According to an embodiment, the operators include at least one of the following:

an operator +, signifying two or more operands put in series;

an operator |, signifying a parallel relationship between two or more operands;

an operator ( ), indicating operands forming a non-negligible combination;

an operator [ ], indicating operands forming a negligible combination;

an operator ;, indicating the end of a sentence;

an operator : indicating explanation of a word category in the word category description file;

an operator “ ”, indicating a reference to an external dictionary.

According to an embodiment, the functions in the grammar description file include at one of the following:

a function &repeat (EXP, min, max), signifying repeating a grammar portion EXP at least min times, and at most max times;

a function &repeat (EXP, n), signifying repeating EXP n times;

a function &perm (EXP1, EXP2, . . . ), signifying making a full permutation of EXP1, EXP2, . . . ;

a function &grammar (grammar_name), indicating a grammar description file with the name of “grammar_name”;

a function &magic (EXP, key, default, display) or a function &magic (EXP, key, default), mapping EXP to the semantic tag “the “key””, wherein for the function &magic (EXP, key, default) in a grammar matching process, when EXP is successfully matched with a section T of a text, the “key” has a value of T, otherwise, the “key” has the value of “default”, and for the function &magic (EXP, key, default, display) in a grammar matching process, when EXP is successfully matched with a section T of text, the value of the “key” is the value of “display”, otherwise the “key” has a value of “default”.

According to an embodiment, the functions in the word category description file include at least one of the following:

a function &repeat (EXP, min, max), signifying repeating a grammar portion EXP at least min times, and at most max times;

a function &repeat (EXP, n), signifying repeating EXP n times.

a function &perm (EXP1, EXP2, . . . ), signifying making a full permutation of EXP1, EXP2, . . . .

According to an embodiment, on the grammar tree of the semantic meaning, leaf nodes are word categories or referenced external dictionary, non-leaf nodes are operators or function names, the operands of non-leaf nodes are the contents of respective sub-trees of the non-leaf nodes.

According to an embodiment, the function &magic (EXP, key, default, display) or the function &magic (EXP, key, default) in the grammar tree of the semantic meaning are marked as non-leaf nodes, and there exist corresponding mapping tables for the function &magic (EXP, key, default, display) or the function &magic (EXP, key, default).

In an embodiment, a semantic parsing method, comprises:

Matching a text to be parsed according to a defined sequence (which may be pre-defined) onto a grammar tree obtained with the aforementioned grammar compiling methods, wherein if the text to be parsed is completely matched with the grammar tree, it is determined that the corresponding semantic meaning of the grammar tree is the semantic meaning of the text to be parsed.

According to an embodiment, during the matching process, if a section of the text to be parsed is matched with a sub-tree marked by the function &magic (EXP, key, default, display) or the function &magic (EXP, key, default), in the parsing result, the value of the “key” in the corresponding mapping table of the function &magic (EXP, key, default, display) or the function &magic (EXP, key, default) is the section of the text or the value of the “display” in the mapping table.

In an embodiment, a semantic parsing method comprises:

carrying out a forward maximum matching on a text to be parsed according to a defined sequence (which may be pre-defined) onto a grammar tree obtained with the aforementioned grammar compiling method, wherein, if the text to be parsed has a section that matches a sub-tree marked by a function &magic (EXP, key, default, display) or a function &magic (EXP, key, default) in the grammar tree, it is determined that the corresponding semantic meaning of the grammar tree is the semantic meaning of the text to be parsed.

According to an embodiment, in the parsing result, the value of the “key” in the corresponding mapping table of the matched function &magic (EXP, key, default, display) or function &magic (EXP, key, default) is the section of the text or the value of “display” in the mapping table.

According to an embodiment, the corresponding semantic meaning of the grammar tree is determined to be the semantic meaning of the text to be parsed only if a section of the text is matched with a sub-tree of a critical function &magic (EXP, key, default, display) or a critical function &magic (EXP, key, default) defined (or pre-defined) on the grammar tree.

In an embodiment, a semantic parsing method comprises:

S1, matching a text to be parsed onto a grammar tree obtained with the aforementioned grammar compiling method according to a defined sequence (which may be pre-defined), wherein if the text to be parsed is completely matched with the grammar tree, it is determined that the corresponding semantic meaning of the grammar tree is the semantic meaning of the text to be parsed, otherwise, step S2 is executed;

S2, carrying out a forward maximum matching on the text to be parsed onto the grammar tree according to the defined sequence, wherein, if the text to be parsed has a section that matches a sub-tree marked by a function &magic (EXP, key, default, display) or a function &magic (EXP, key, default) in the grammar tree, it is determined that the corresponding semantic meaning of grammar tree is the semantic meaning of the text to be parsed.

According to an embodiment, in the parsing result, the value of the “key” in the corresponding mapping table of the matched function &magic, (EXP, key, default, display) or function &magic (EXP, key, default) is the section of the text or the value of “display” in the mapping table.

In an embodiment, a grammar compiling device comprises:

a file storage unit, used to store a corresponding grammar description file and a corresponding word category description file for a semantic meaning, wherein the grammar description file and the corresponding word category description file are defined (or pre-defined) based on a logical grammar by manifest language LGML according to a common sentence expression of the semantic meaning, in the grammar description file, the description for a common sentence is composed by operators, word categories, and functions, the word category description file is used to describe specific values for the word categories;

and a grammar tree generation unit, for respectively generating the grammar description file and the word category file into a grammar tree for the grammar description file and word category trees for the word category file with a reduction method of a defined sequence (which may be pre-defined), and grafting the word category trees to the positions of the corresponding word categories on the grammar tree, forming a grammar tree for the semantic meaning.

According to an embodiment, the word category description file comprises word items, or comprises, besides word items, at least one of the operators and functions to describe relationships between word items.

According to an embodiment, the operators include at least one of the following:

an operator +, signifying two or more operands put in series;

an operator |, signifying a parallel relationship between two or more operands;

an operator ( ), indicating operands forming a non-negligible combination;

an operator [ ], indicating operands forming a negligible combination;

an operator ;, indicating the end of a sentence;

an operator : indicating explanation of a word category in the word category description file;

an operator “ ”, indicating a reference to an external dictionary.

According to an embodiment, the functions in the grammar description file include at one of the following:

a function &repeat (EXP, min, max), signifying repeating a grammar portion EXP at least min times, and at most max times;

a function &repeat (EXP, n), signifying repeating EXP n times;

a function &perm (EXP1, EXP2, . . . ), signifying making a full permutation of EXP1, EXP2, . . . ;

a function &grammar (grammar_name), indicating a grammar description file with the name of “grammar_name”;

a function &magic (EXP, key, default, display) or a function &magic (EXP, key, default), mapping EXP to the semantic tag “the “key””, wherein for the function &magic (EXP, key, default) in a grammar matching process, when EXP is successfully matched with a section T of a text, the “key” has a value of T, otherwise, the “key” has the value of “default”, and for the function &magic (EXP, key, default, display) in the grammar matching process, when EXP is successfully matched with a section T of text, the value of the “key” is the value of “display”, otherwise the “key” has a value of “default”.

According to an embodiment, the functions in a word category description file include at least one of the following:

a function &repeat (EXP, min, max), signifying repeating a grammar portion EXP at least min times, and at most max times;

a function &repeat (EXP, n), signifying repeating EXP n times.

a function &perm (EXP1, EXP2, . . . ), signifying making a full permutation of EXP1, EXP2, . . . .

According to an embodiment, on the grammar tree of the semantic meaning, leaf nodes are word categories or referenced external dictionary, non-leaf nodes are operators or function names, the operands of non-leaf nodes are the contents of respective sub-trees of the non-leaf nodes.

According to an embodiment, the function &magic (EXP, key, default, display) and the function &magic (EXP, key, default) are marked as non-leaf nodes, and there are corresponding mapping tables for the function &magic (EXP, key, default, display) and the function &magic (EXP, key, default) in the file storage unit.

In an embodiment, a semantic parsing device comprises:

a whole-sentence matching unit, used to parse a text to be parsed according to a defined sequence (which may be pre-defined) onto a grammar tree obtained with the aforementioned grammar compiling devices, wherein, if it is determined that the text to be parsed completely matches the grammar tree, the matching result is sent to a result determination unit;

a result determination unit, wherein, when receiving the matching result, it determines that the corresponding semantic meaning of the grammar tree is the semantic meaning of the text to be parsed.

According to an embodiment, in the case where the grammar tree is obtained with the aforementioned grammar compiling device, during the matching process, if a section of the text to be parsed is matched with a sub-tree marked by the function &magic (EXP, key, default, display) or the function &magic (EXP, key, default), in the parsing result, the value of the “key” in the corresponding mapping table of the function &magic (EXP, key, default, display) or the function &magic (EXP, key, default) is the section of the text or the value of the “display” in the mapping table.

In an embodiment, a semantic parsing device comprises:

a semantic mapping matching unit, used to carry out a forward maximum matching on the text to be parsed according to a defined sequence (which may be pre-defined) onto a grammar tree obtained with the aforementioned grammar compiling device, wherein, if the text to be parsed has a section that matches a sub-tree marked by a function &magic (EXP, key, default, display) or a function &sub-tree magic (EXP, key, default) in the grammar tree, the matching result is sent to a result determination unit;

a result determining unit, wherein, when receiving the matching result, it determines that the corresponding semantic meaning of the grammar tree is the semantic meaning of the text to be parsed.

According to an embodiment, wherein in the parsing result obtained by the result determination unit, the value of the “key” in the corresponding mapping table of the function &magic (EXP, key, default, display) or the function &magic (EXP, key, default) is the section of the text or the value of the “display” in the mapping table.

According to embodiment, the semantic mapping matching unit sends the matching result to the result determination unit only if there exists a section of the text to be parsed successfully matched with a sub-tree marked by a critical function &magic (EXP, key, default, display) or a critical function &magic (EXP, key, default) defined (or pre-defined) on the grammar tree.

In an embodiment, a semantic parsing device comprises:

a whole-sentence matching unit, used to parse a text to be parsed according to the defined sequence (which may be pre-defined) onto a grammar tree obtained by the aforementioned grammar compiling device, wherein if it is determined that the text to be parsed completely matches the grammar tree, the matching result is sent to a result determination unit, otherwise a semantic mapping matching unit is triggered;

a semantic mapping matching unit, wherein, after triggered, the semantic mapping matching unit carries out a forward maximum matching on the text to be parsed according to the defined sequence onto the grammar tree, if the text to be parsed has a section that matches a sub-tree marked by a function &magic (EXP, key, default, display) or a function &sub-tree magic (EXP, key, default) in the grammar tree, the matching result is sent to a result determination unit;

and a result determining unit, wherein, when receiving the matching result, it determines that the corresponding semantic meaning of the grammar tree is the semantic meaning of the text to be parsed.

According to an embodiment, if the result determination unit receives result from the semantic mapping matching unit, the value of the “key” in the corresponding mapping table of the matched function &magic (EXP, key, default, display) or function &magic (EXP, key, default) is the section of the text or the value of the “display” in the mapping table.

In an embodiment, the grammar compiling methods and semantic parsing method provided are based on grammar description files and word category description files by the LGML, are more similar to human spoken language, have lower parsing level than BNF and XML, and have improved improve readability and maintainability.

### BRIEF DESCRIPTION OF THE DRAWINGS

FIG. 1a is a schematic diagram of the grammar tree of a grammar description file according to an embodiment;

FIGS. 1b, 1c, and 1d are schematic diagrams of the word category trees of a word category file according to an embodiment;

FIG. 1e is a schematic diagram of the grammar tree of a semantic meaning according to an embodiment;

FIG. 2a is the view of an actual example of the grammar tree of a grammar description file according to an embodiment;

FIGS. 2b and 2c are the views of an actual example of the word category trees of a word category file according to an embodiment;

FIG. 2d is the view of an actual example of the grammar tree of a semantic meaning according to an embodiment;

FIG. 3 is the corresponding grammar tree of the semantic meaning for a weather query according to an embodiment;

FIG. 4 is a structure diagram of a grammar compiling device according to an embodiment;

FIG. 5 is a structure diagram of a first semantic parsing device according to an embodiment;

FIG. 6 is a structure diagram of a second semantic parsing device according to an embodiment;

FIG. 7 is a structure diagram of a third semantic parsing device according to an embodiment;

### DETAILED DESCRIPTION

A grammar compiling method of an embodiment is based on a new grammar description language, namely, a logical grammar by manifest language (LGML), which differs from the complex structure of the existing BNF or XML and is closer to the sequence and description style of the natural oral language. For common sentence expressions of respective semantic meanings, the LGML is used to define corresponding grammars (which may be pre-defined); a grammar is composed of two parts: a grammar description file and a word description file.

In a grammar description file, a sentence description is composed by operators, word categories, and functions. The grammar description file typically uses an exhaustive list to define a variety of sentence descriptions. Word categories and functions in the grammar description file are usually used as operands for operators. Besides being used as separate operating objects, word categories can be used in the grammar description file as parameters of functions. A word category is a unified marking for a certain number of word items (words or phrases) with the same meaning. Specific word items belonging to a word category are defined in the corresponding word category description file of the word category; in other words, a word category description file is used to describe specific values of word categories. Operators and/or functions can also be included in the word category description to describe relationships between word items. A word category description file can be defined manually, or can be the results of machine mining.

Next, the detailed structure of the LGML according to various example embodiments will be described in detail. First, operators in grammar description files and word category description files may include, but not limited to, the following:

The operator + signifies two or more operands put in series; “put in series” means describing a sentence in sequence.

The operator | signifies a parallel relationship between two or more operands; the so-called “parallel relationship” means one of the operands is selected for the same meaning.

The operator ( ) indicates operands forming a non-negligible combination.

The operator [ ] indicates operands forming a negligible combination.

The operator ; indicates the end of a sentence.

The operator : indicates explanation of a word category in the word category description file.

The operator “ ” indicates reference to an external dictionary, words in the dictionary have parallel relationship.

Functions in a word category description file may include, but not limited to, the following:

The function &repeat (EXP, min, max) signifies repeating a grammar portion EXP at least min times, and at most max times.

The function &repeat (EXP, n) signifies repeating EXP n times.

The function &perm (EXP1, EXP2, . . . ) signifies making a full permutation of EXP1, EXP2, . . . . For example: &perm (EXP1, EXP2, EXP3) is equivalent to put 6 items in parallel:

(EXP1+EXP2+EXP3)|(EXP1+EXP3+EXP2)|(EXP2+EXP3+EXP1)|(EXP2+EXP1+EXP3)|(EXP3+EXP1+EXP2)|(EXP3+EXP2+EXP1)

In addition to the aforementioned function &repeat (EXP, min, max), function &repeat (EXP, n), and the function &perm (EXP1, EXP2, . . . ), a grammar description file can also include, but not limited to, the following functions:

The function &grammar (grammar_name) is usually written at the beginning of the grammar file, indicating the name of the grammar for a sentence expression is “grammar_name”, which marks the grammar description file for the sentence expression.

The function &magic (EXP, key, default, display) and the function &magic (EXP, key, default) map EXP to the semantic tag “key”.

For the function &magic (EXP, key, default) in a grammar matching process, when EXP is successfully matched with a section T of a text, the “key” has a value of T. Otherwise, the “key” has the default value of “default”.

For the function &magic (EXP, key, default, display) in a grammar matching process, when EXP is successfully matched with a section T of text, the value of the “key” is the displayed value “display”, otherwise the “key” has a value of “default”.

Here is an example. Assume a sentence for whether query has a defined grammar description file and a word category description file, the grammar description file can be defined as:

&grammar(weather);
[ [symbol] intention [symbol] + [symbol] query [symbol] ]+
&perm(
&magic([ [symbol] time [symbol] ], date, today), &magic([ [symbol] place [symbol] ], place, LBS)
)+[of]+&magic( [symbol] weather index [symbol] , weather, error, weather);
......

The word category description file can be defined as:

[symbol]

intention [symbol] : I +(want to | would like to); [symbol]
query [symbol] : know | query; [symbol]
time [symbol] : today | tomorrow; [symbol]
place [symbol] : &repeat( “place.dic” +[province| city], 1,2); [symbol]
weather index [symbol] : temperature | humidity;
......

The grammar compiling according to an embodiment is to compile a semantic meaning into a grammar tree based on the LGML. During compiling of the grammar tree, a reduction method of determined sequence (from left to right in the present example embodiments) is carried out on the aforementioned grammar description file and word category description file; the grammar tree is generated according to the relationships under the functions and operators. Specifically, the grammar description file is generated into a grammar tree with the reduction method from left to right, and the word category description file is generated into word category trees with the reduction method from left to right. And then the word category trees are grafted at the positions of corresponding word categories in the grammar tree; in the end, the word category trees are grafted to leaf nodes of the grammar tree.

During generating of the grammar description file into a grammar tree, leaf nodes are word categories, non-leaf nodes are operators, the operands of an operator as a non-leaf node are the contents of respective sub-trees of the non-leaf node. The function &repeat (EXP, min, max), &repeat (EXP, n), &perm (EXP1, EXP2, . . . ) can all be expressed in the form of the combination of the grammar section EXP and operators. While the function &magic (EXP, key, default, display) and &magic (EXP, key, default) are implemented for mapping relationships; the function of &magic is marked in the following way: it appears on the grammar tree as a non-leaf node, in the meanwhile, there is a corresponding mapping table for the function &magic, for example, there may be a location pointer between the marking of the function &magic and the corresponding mapping table.

Below are some simple examples. Assume the grammar description file of a semantic meaning has the following content:

[ [symbol] A [symbol] + [symbol] B [symbol] ]| [symbol] C

[symbol]

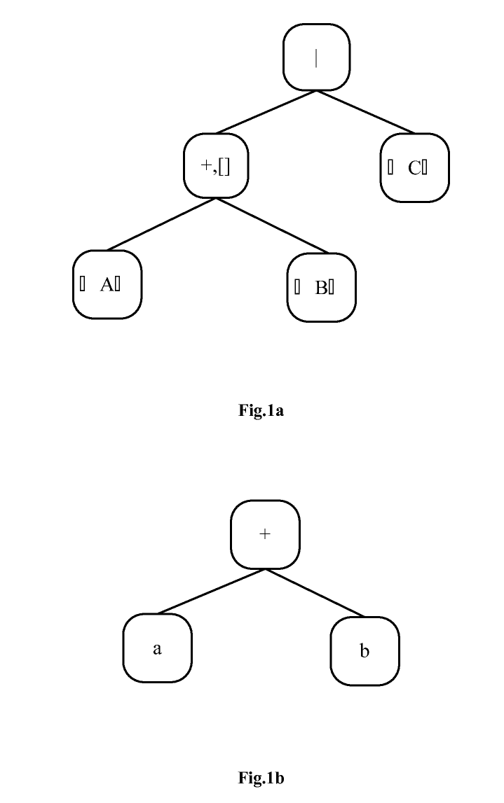

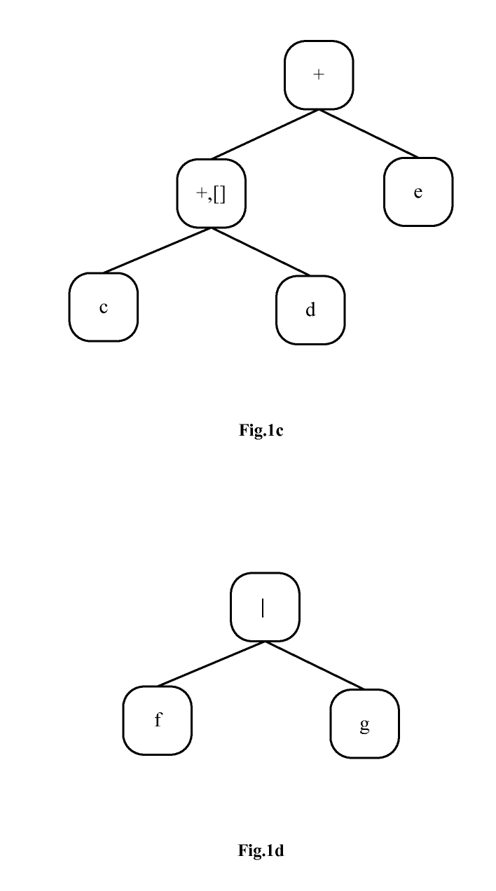

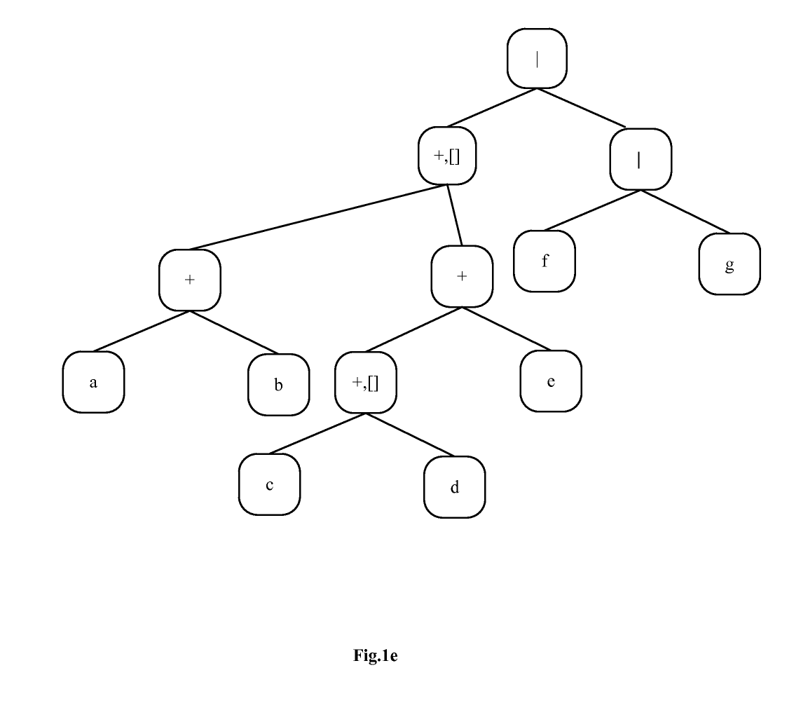

A reduction is made from left to right. The resulting grammar tree of the grammar description file is shown in FIG. 1a. In FIG. 1a, leaf nodes are word categories [symbol] A [symbol] , [symbol] B [symbol] , and [symbol] C [symbol] , the non-leaf nodes are operators. The operands for the non-leaf nodes “+, [ ]” are [symbol] A [symbol] and [symbol] B [symbol] . The operands for the non-leaf node “I” are the contents of its respective sub-trees, the sub-tree content of the left branch is [ [symbol] A [symbol] + [symbol] B [symbol] ], the sub-tree content of the right branch is [symbol] C [symbol] .

If the word category description file of the semantic meaning is as follows:

a+b; [symbol] A [symbol] :

[c+d]+e; [symbol] B [symbol] :

f|g; [symbol] C [symbol] :

A reduction is carried out on the word categories from left to right, the word category trees for the word categories [symbol] A [symbol] , [symbol] B [symbol] and [symbol] C [symbol] are respectively shown in FIGS. 1b, 1c, and 1d. Next, the word category trees are grafted to the grammar tree of the grammar description file at the positions of corresponding word categories, eventually forming the grammar tree for the aforementioned semantic expression, as shown in FIG. 1e.

Assume the grammar description file for a certain semantic meaning has the following content:

&magic(( [symbol] X [symbol] | [symbol] Y [symbol] ),key,default,display)

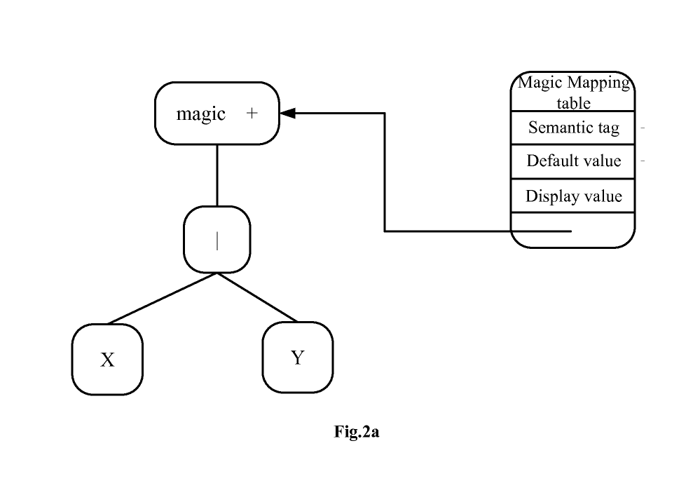

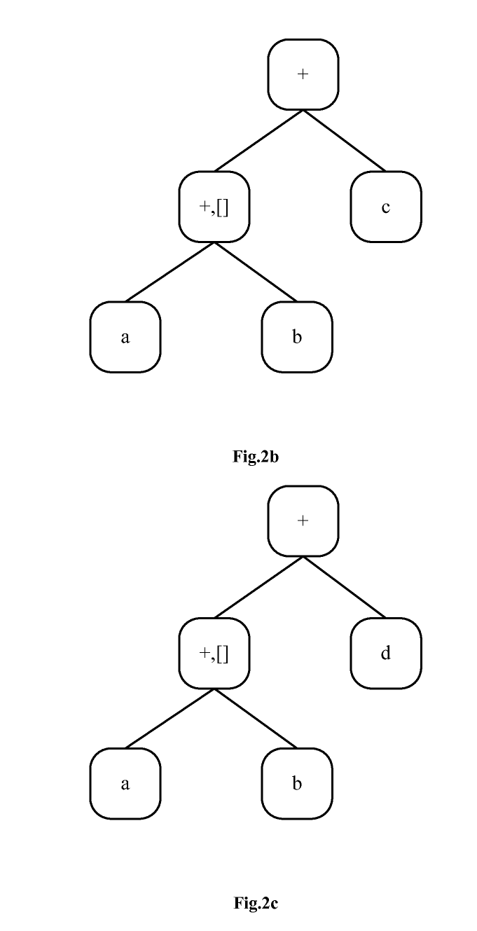

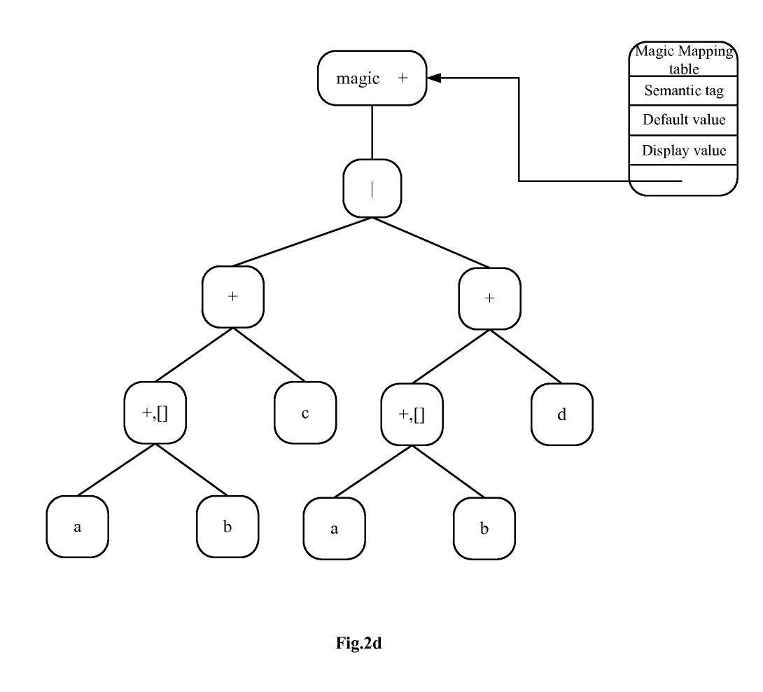

A reduction is made from left to right. The resulting grammar tree of the grammar description file is shown in FIG. 2a. The non-leaf node “magic, +” marks the function &magic, and there is a magic mapping table, and the position of the grammar tee of the function magic in the mapping table is indicated.

Assume the word category description file of the semantic meaning is as follows:

[a+b]+c; [symbol] X [symbol] :

[a+b]+d; [symbol] Y [symbol] :

A reduction is carried out on the word categories from left to right, the word category trees for the word categories [symbol] X [symbol] and [symbol] Y [symbol] are respectively shown in FIGS. 2b and 2c. Next, the word category trees are grafted on the grammar tree of the grammar description file at the positions of corresponding word categories, eventually forming the grammar tree for the aforementioned semantic meaning, as shown in FIG. 2d.

In other words, in the eventually formed grammar tree for the semantic meaning, the leaf nodes are word items in the word category description file or referenced external dictionary, the non-leaf nodes are operators or function names, operands of the non-leaf nodes are contents represented by the sub-trees of the non-leaf nodes.

If there are two or more functions &magic in the grammar description file, one can merge all the mapping tables of the functions &magic in the grammar description file into one mapping table to facilitate storage and query.

After completion of the aforementioned grammar compiling, one can make semantic paring based on the grammar tree formed through grammar compiling. The text to be parsed, for example, can be the text result from recognition of a user's speech, which can be semantically parsed to obtain its semantic meaning. It can also be the text input into a search engine by a user, which can be semantically parsed to obtain its semantic meaning. The aforementioned are only non-exhaustive examples.

During semantic parsing, the text to be parsed is matched with respective grammar trees. The matching is done from left to right, the corresponding semantic meaning of the matched grammar tree is determined to be the semantic meaning of the text to be parsed. In the matching process, a way of whole-sentence matching can be used, or a way of semantic mapping matching can be used; or the combination of whole-sentence matching and semantic mapping matching can be used, e.g., whole-sentence matching is carried out first, if it gives no result, a semantic mapping matching is carried out. The so-called whole-sentence matching is the case where the text to be parsed can be completely matched with the grammar tree of LGML of a certain semantic meaning. This matching is a versatile and accurate way of matching, regardless of what functions are used in the LGML. In a semantic mapping matching, a section of the text to be parsed can be matched with a section of the grammar defined by the functions &magic, e.g., if the whole or part of the text to be parsed can be matched with a sub-tree marked by the functions &magic on the grammar tree, it is then determined that the semantic meaning of the text includes the semantic meaning mapped from the function &magic.

During whole-sentence matching, the way the text to be parsed is matched with the grammar tree is substantially the same with existing grammar tree matching ways, the difference is that the present matching is carried out from left to right, and a successful matching is found only in the case where the text to be parsed can be completely matched onto the grammar tree. In particular, during matching, if matching with a sub-tree marked by a function &magic is found, based on the matching result of the sub-tree marked by the function &magic, the mapping result obtained from the mapping table indicated by the function &magic is taken as the parsing result. That is, if a certain section of the text to be parsed is completely matched with a sub-tree marked by the function &magic, for the parsing results, the value of the “key” in the mapping table indicated by the function &magic is the section of the text or the value of “display” in the mapping table.

The grammar tree shown in FIG. 2b is taken as an example. Assume the text to be parsed is: “abd”. The matching is done from left to right on the grammar tree. No matching is found on the left sub-tree of “I”. But the sub-tree on the right completely matches. Accordingly, it can be determined that the semantic parsing result for “abd” is the semantic meaning of the semantic tree, the value of the “key” in the paring result is the value for the “display”. If the text to be parsed is eabdc, it does not match the grammar tree, the semantic meaning of the grammar tree is not that for the text to be parsed.

For the special function of &magic, a semantic mapping matching can be used on its marked sub-tree, e.g., a forward maximum matching is carried out on the sub-tree marked by the function &magic and the text to be parsed. If the text to be parsed has a section that matches the sub-tree marked by the function &magic, it then can be determined that the semantic meaning of the text to be parsed is that of the grammar tree; in the parsing result, the value of the “key” in the mapping table indicated by the function &magic is the section of the text or the value of “display” in the mapping table.

Similarly, the grammar tree shown in FIG. 2b is taken as an example. Assume the text to be parsed is: eabdc, a forward maximum matching (e.g., “e” is take as the beginning of the text to be parsed for the matching, if the matching fails, “a” is take as the beginning of the text to be parsed for the matching, if the matching fails, “b” is taken as the beginning, and so on) is carried out on the sub-tree and the text to be parsed. As a result, if the text section abd matches the grammar tree, it can be determined that the semantic meaning of the text to be parsed is that of the grammar tree, in the parsing result, the value of the “key” is the value of “display”.

In view of the accuracy of the whole-sentence matching and the high coverage of the semantic mapping matching, to integrate the advantages of the two ways of matching, embodiments may employ the whole-sentence matching followed by the semantic mapping matching, e.g., if the whole-sentence matching fails, a semantic mapping matching is carried out.

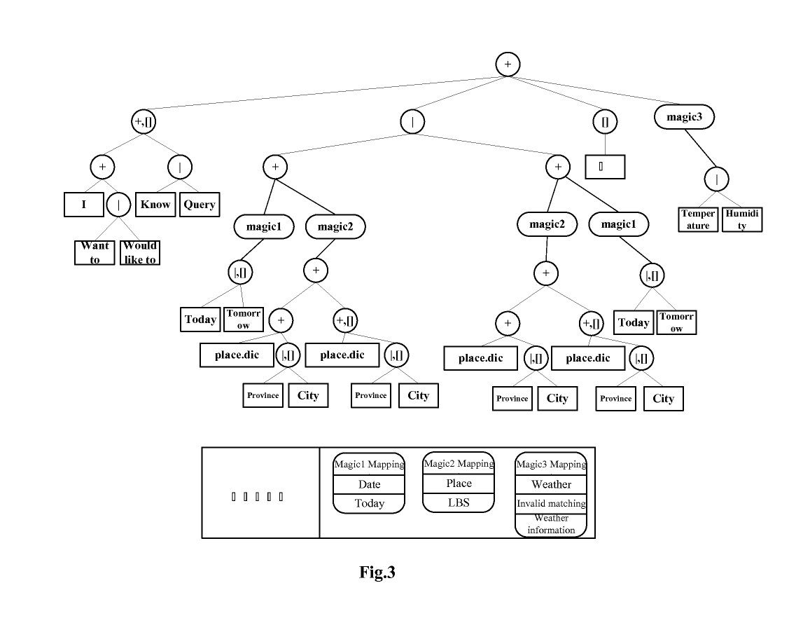

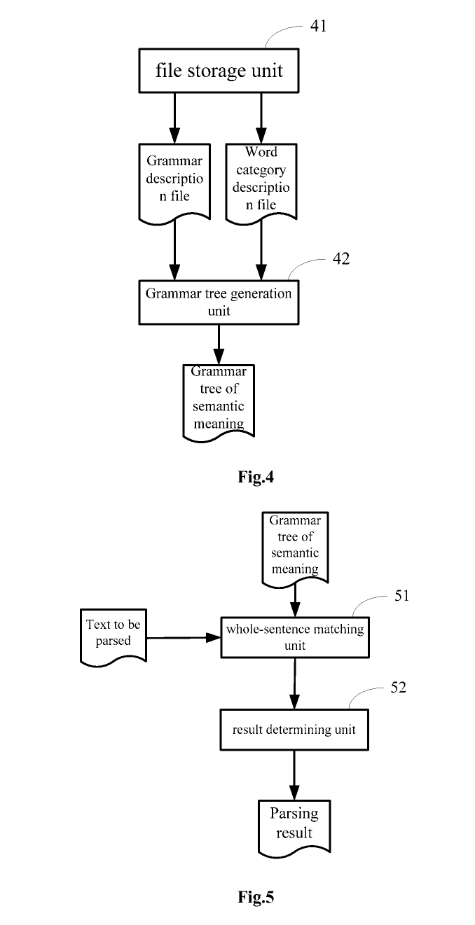

Below is a specific example. Assume the grammar tree for the semantic meaning of a query about weather is shown in FIG. 3. As shall be noticed, in the figure, the markings “magic” of the functions &magic are numbered for convenience, while in reality, the markings for the nodes magic on the grammar tree may be identical, but there are corresponding location pointers in the magic mapping table. In FIG. 3, for the sake of clarity, location pointers are not used, the magic markings are numbered to represent the pointing relationship with the magic mapping table. Furthermore, in reality, the respective magic mapping tables may be combined into one mapping table form.

If the text to be parsed is “I want to know Beijing temperature”, whole-sentence matching can be successfully carried out, magic1 is mapped to “today”, magic2 is mapped to “Beijing”, magic3 is mapped to “weather”, the semantic meaning of the text to be parsed is therefore to query the weather. In the parsing results, the date has a value of “today”, the place has a value of “Beijing”, and the weather has the value of “weather”, although the user did not say “today”, according to the grammar, the operator [ ] of magic1 is negligible, its value is therefore the default value “today”.

If the text to be parsed is “Tell me temperature”, as the grammar does not define relevant grammar section for “Tell me”, the whole-sentence matching fails, then a semantic mapping matching is carried out, the text section “temperature” is successfully matched with the sub-tree of magic3, the semantic mapping matching is successful, one can still deem the text to be parsed has a semantic meaning of “weather query”, magic1 is mapped to “today”, magic2 is mapped to “LBS”, magic3 is mapped to “weather”. Accordingly, in the parsing result, the date of the parsing result has a value of “today”, the place has a value of “LBS”, and weather has a value of “weather”.

Also, during semantic mapping matching, a critical magic function can be set, so that the semantic mapping matching is deemed successful only if the sub-tree of the critical magic function is successfully matched. For example, the function magic3 on the grammar tree shown in FIG. 3 can be set as the critical magic function, the semantic mapping matching is deemed successful only if the sub-tree of this magic function is successfully matched. For example, when the text to be parsed is “I want to know Beijing”, although the whole-sentence matching for “I want to know Beijing” fails, the text section “Beijing” is successfully matched with the sub-tree for the function magic2, but the critical function magic3 is not successfully matched, it is still not considered to have a successful semantic mapping matching, and therefore the text to be parsed cannot be considered to have the semantic meaning for “weather query”.

It is possible to have the following situation: during semantic mapping matching onto a grammar tree of a semantic meaning, the sub-trees of a plurality of &magic functions are able to be matched with the text to be parsed. To resolve the conflict in this case, one can use defined priority levels of the sub-trees, or the maximum constraint for the matched word items.

The above is a description of an embodiment of a method. An embodiment of a device is described below.

FIG. 4 is a block diagram of a grammar compiling device according to an embodiment. As shown in FIG. 4, the grammar compiling device includes a file storage unit 41 and a grammar tree generation unit 42.

The file storage unit 41 stores the grammar description file and the corresponding word category description file for the semantic meaning. The grammar description file and the corresponding word category description file are defined based on the LGML according to a common sentence expression of the semantic meaning. In the grammar description file, the description of a common sentence is composed of word categories, operators, and functions. The word category file is used to describe specific values for word categories.

The word category description file comprises word items, or comprises, besides word items, at least one of operators or functions to describe relationships between word items.

The operators in the grammar description file and the word category description file may include, but not limited to, the following:

The operator + signifies two or more operands put in series.

The operator | signifies a parallel relationship between two or more operands.

The operator ( ) indicates operands forming a non-negligible combination.

The operator [ ] indicates operands forming a negligible combination.

The operator ; indicates the end of a sentence.

The operator : indicates explanation of a word category in the word category description file.

The operator “ ” indicates reference to an external dictionary.

Functions in a word category description file may include, but not limited to, the following:

The function &repeat (EXP, min, max) signifies repeating a grammar portion EXP at least min times, and at most max times.

The function &repeat (EXP, n) signifies repeating EXP n times.

The function &perm (EXP1, EXP2, . . . ) signifies making a full permutation of EXP1, EXP2, . . . . For example: &perm (EXP, EXP2, EXP3) is equivalent to put 6 items in parallel:

(EXP1+EXP2+EXP3)|(EXP1+EXP3+EXP2)|(EXP2+EXP3+EXP1)|(EXP2+EXP1+EXP3)|(EXP3+EXP1+EXP2)|(EXP3+EXP2+EXP1)

In addition to the aforementioned function &repeat (EXP, min, max), function &repeat (EXP, n), and the function &perm (EXP1, EXP2, . . . ), a grammar description file can also include, but not limited to, the following functions:

The function &grammar (grammar_name) is usually written at the beginning of the grammar file, indicating the name of the grammar for a sentence is “grammar_name”, which marks the grammar description file for the sentence.

The function &magic (EXP, key, default, display) and function &magic (EXP, key, default) maps EXP to the semantic tag the “key”.

For the function &magic (EXP, key, default) in a grammar matching process, when EXP is successfully matched with a section T of a text, the “key” has a value of T. Otherwise, the “key” has the value of default.

For the function &magic (EXP, key, default, display) in a grammar matching process, when EXP is successfully matched with a section T of text, the value of the “key” is “display”, otherwise the value of the “key” is default.

The grammar tree generation unit 42 is responsible for respectively generating the grammar description file and the word category file into a grammar tree for the grammar description file and word category trees for the word category file with the reduction method of a defined sequence (for example, from left to right), and grafting the word category trees to the positions of the corresponding word categories on the grammar tree.

During generating of the grammar description file into a grammar tree, leaf nodes are word categories, non-leaf nodes are operators, the operands of an operator as a non-leaf node are the contents of respective sub-trees of the non-leaf node. The function &repeat (EXP, min, max), &repeat (EXP, n), &perm (EXP1, EXP2, . . . ) can all be expressed in the form of the combination of the grammar section EXP and operators. While the function &magic (EXP, key, default, display) and &magic (EXP, key, default) are implemented for mapping relationships, the function of &magic is marked in the following way: it appears on the grammar tree as a non-leaf node, in the meanwhile, there is a corresponding semantic mapping for the function &magic, for example, there may be a location pointer between the marking of the function &magic and the corresponding mapping table.

In the eventually formed grammar tree for the semantic meaning, the leaf nodes are word items in the word category description file or referenced external dictionary, the non-leaf nodes are operators or function names, operands of non-leaf nodes are contents represented by the sub-trees of the non-leaf nodes.

If there are two or more functions &magic in the grammar description file, one can merge all the mapping tables of the functions &magic in the grammar description file into one mapping table to facilitate the storage and query.

Based on the grammar tree of the semantic meaning obtained with the grammar compiling device shown in FIG. 4, the semantic parsing device of an embodiment may be implemented with three structures, one uses the whole-sentence matching method, another uses the semantic mapping matching method, and a further one uses a combination of the whole-sentence matching method and the semantic mapping matching method.

FIG. 5 is the structure view of a first semantic parsing device according to an embodiment, the semantic parsing device uses the whole-sentence matching method. As shown in FIG. 5, the semantic parsing device comprises a whole-sentence matching unit 51 and a result determining unit 52.

The whole-sentence matching unit 51 matches the text to be parsed on the above grammar tree of the semantic meaning according to a defined sequence, if it is determined that the text to be parsed completely matches the grammar tree, the matching result is sent to the result determination unit 52.

When the result determination unit 52 receives the matching result, it is determined that the corresponding semantic meaning of the grammar tree is the semantic meaning of the text to be parsed.

As can be seen, the whole-sentence matching is the case where the text to be parsed can be completely matched with the grammar tree of LGML of a certain semantic meaning. This matching is a versatile and accurate way of matching, regardless of what functions are used in the LGML.

In particular, during whole-sentence matching, the sub-trees marked by &magic function may be matched, if a section of the text to be parsed is matched with a sub-tree marked by the function &magic (EXP, key, default, display) or the function &magic (EXP, key, default), in the parsing result obtained by the result determination unit 52, the value of the “key” in the corresponding mapping table of the function &magic (EXP, key, default, display) or the function &magic (EXP, key, default) is the section of the text or the value of the “display” in the mapping table.

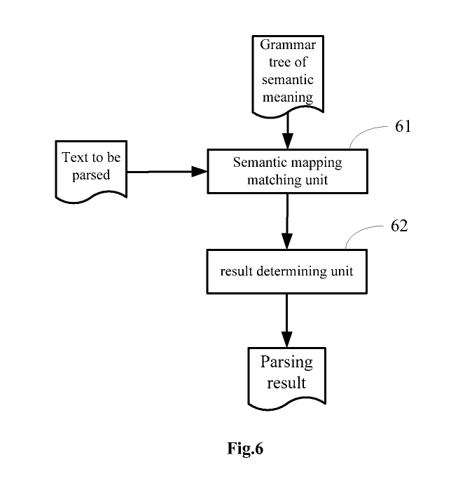

FIG. 6 is the structure view of a second semantic parsing device according to an embodiment, the semantic parsing device only uses the semantic mapping matching method. As shown in FIG. 6, the semantic parsing device comprises a semantic mapping matching unit 61 and a result determining unit 62.

The semantic mapping matching unit 61 carries out a forward maximum matching on the text to be parsed according to a defined sequence onto the grammar tree of a semantic meaning. If the text to be parsed has a section that matches a sub-tree marked by the function &magic (EXP, key, default, display) or the function &sub-tree magic (EXP, key, default), the matching result is sent to the result determination unit 62.

When the result determination unit 62 receives the matching results, it is determined that the corresponding semantic meaning of the grammar tree is the semantic meaning of the text to be parsed. Further, in the parsing result obtained by the result determination unit 62, the value of the “key” in the corresponding mapping table of the function &magic (EXP, key, default, display) or the function &magic (EXP, key, default) is the section of the text or the value of the “display” in the mapping table.

Also, during semantic mapping matching, a critical magic function can be set, so that the semantic mapping matching is deemed successful only if the sub-tree of the critical magic function is successfully matched. That is, the semantic mapping matching unit 61 sends the matching result to the result determination unit 62 only if there exists a section of the text to be parsed successfully matched with a sub-tree marked by the critical function &magic (EXP, key, default, display) or the critical function &magic (EXP, key, default) defined on the grammar tree.

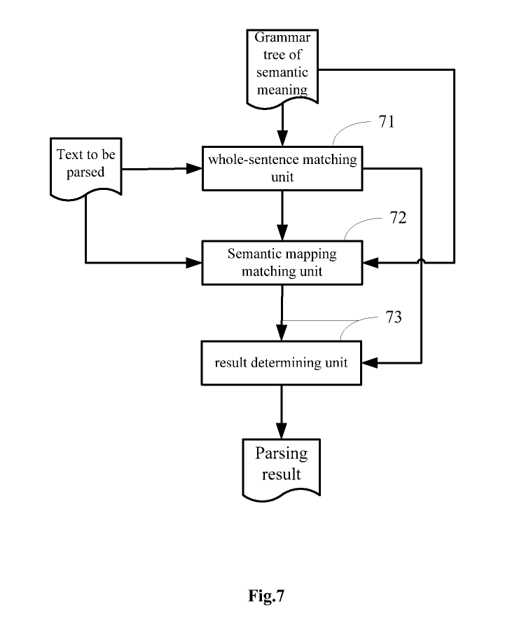

FIG. 7 is the structure view of a third semantic parsing device according to an embodiment, the semantic parsing device uses a combination of the whole-sentence matching method and the semantic mapping matching method. As shown in FIG. 7, the semantic parsing device comprises a whole-sentence matching unit 71, a semantic mapping matching unit 72, and a result determining unit 73.

The whole-sentence matching unit 71 matches the text to be parsed according to a defined sequence onto the grammar tree, if it is determined that the text to be parsed completely matches the grammar tree, the matching result is sent to the result determination unit 72, otherwise the semantic mapping matching unit 72 is triggered.

After being triggered, the semantic mapping matching unit 72 carries out a forward maximum matching on the text to be parsed according to a defined sequence onto the grammar tree. If the text to be parsed has a section that matches a sub-tree marked by the function &magic (EXP, key, default, display) or the function &sub-tree magic (EXP, key, default), the matching result is sent to the result determination unit 73.

Regardless of what the result determination unit 73 receives, either the result from the whole-sentence matching unit 71 or that from the semantic mapping matching unit 72, the unit 73 can determine that the corresponding semantic meaning of the grammar tree is the semantic meaning of the text to be parsed.

Further, if the result determination unit 73 receives result from the semantic mapping matching unit 72, the value of the “key” in the corresponding mapping table of the matched function &magic (EXP, key, default, display) or the function &magic (EXP, key, default) is the section of the text or the value of the “display” in the mapping table.

Similarly, during semantic mapping matching, a critical magic function can be set, so that the semantic mapping matching is deemed successful only if the sub-tree of the critical magic function is successfully matched. That is, the semantic mapping matching unit 72 sends the matching result to the result determination unit 73 only if there exists a section of the text to be parsed successfully matched with the sub-trees marked by the critical function &magic (EXP, key, default, display) or critical function &magic (EXP, key, default) defined on the grammar tree.

The following should be particularly noticed: during semantic parsing, usually the grammar trees of the respective semantic meanings are matched one by one to determine the corresponding semantic meaning of the text to be parsed. The description of example embodiments is based on examples of matching on one grammar tree, the matching processes for different grammar trees are similar. In addition, in some applications, multi-level semantic parsing is used; in such a case, during semantic parsing in each level, the semantic parsing method and semantic parsing device according to an embodiment may be used.

It should be understood that the devices and methods disclosed can be implemented through other ways. For example, the embodiments for the devices are exemplary, e.g., the division of the units is merely logical one, in reality, they can be divided in other ways.

The units described as separate parts may be or may not be physically separated, the parts shown as units may be or may not be physical units, e.g., they can be located in one place, or distributed in a plurality of network units. One can select some or all the units to achieve the purpose of the embodiment according to the actual needs.

Further, in the examples, the functional units can be integrated in one processing unit, or they can be separate physical presences; or two or more units can be integrated in one unit. The integrated unit described above can be realized as hardware, or they can be realized with hardware and software functional unit.

The aforementioned integrated unit in the form of software functional units may be stored in a computer readable storage medium. The aforementioned software function unit is stored in a storage medium, including several instructions to instruct a computer device (a personal computer, server, or network equipment, etc.) or processor to perform some steps of the method described in the various embodiments. The aforementioned storage medium may include: U disk, removable hard disk, read-only memory (ROM), a random access memory (RAM), magnetic disk, or an optical disk medium storing program code.

1. A grammar compiling method, wherein the method defines a corresponding grammar description file and a corresponding word category description file based on a logical grammar by manifest language LGML according to a common sentence expression of a semantic meaning, in the grammar description file, the description for a common sentence is composed by operators, word categories, and functions, the word category description file is used to describe specific values for the word categories;
the grammar description file and the word category description file are respectively generated, with a reduction method according to a defined sequence, into a grammar tree for the grammar description file and word category trees for the word category description file; and
the word category trees are grafted at the positions of corresponding word categories on the grammar tree, forming a grammar tree for the semantic meaning.

2. The grammar compiling method according to claim 1, wherein, the word category description file comprises word items, or comprises, besides word items, at least one of the operators and functions to describe relationships between word items.

3. The grammar compiling method according to claim 1, wherein, the operators include at least one of the following:
an operator +, signifying two or more operands put in series;
an operator |, signifying a parallel relationship between two or more operands;
an operator ( ), indicating operands forming a non-negligible combination;
an operator [ ], indicating operands forming a negligible combination;
an operator ;, indicating the end of a sentence;
an operator :, indicating explanation of a word category in the word category description file; and
an operator “ ”, indicating a reference to an external dictionary.

4. The grammar compiling method according to claim 1, wherein the functions in the grammar description file include at least one of the following:
a function &repeat (EXP, min, max), signifying repeating a grammar portion EXP at least min times, and at most max times;
a function &repeat (EXP, n), signifying repeating EXP n times;
a function &perm (EXP1, EXP2, . . . ), signifying making a full permutation of EXP1, EXP2, . . . ;
a function &grammar (grammar_name), indicating a grammar description file with the name of “grammar_name”; and
a function &magic (EXP, key, default, display) or a function &magic (EXP, key, default), mapping EXP to the semantic tag “the “key””, wherein for the function &magic (EXP, key, default) in a grammar matching process, when EXP is successfully matched with a section T of a text, the “key” has a value of T, otherwise, the “key” has the value of “default”, and for the function &magic (EXP, key, default, display) in a grammar matching process, when EXP is successfully matched with a section T of text, the value of the “key” is the value of “display”, otherwise the “key” has a value of “default”.

5. The grammar compiling method according to claim 2, wherein the functions in the word category description file include at least one of the following:
a function &repeat (EXP, min, max), signifying repeating a grammar portion EXP at least min times, and at most max times;
a function &repeat (EXP, n), signifying repeating EXP n times; and
a function &perm (EXP1, EXP2, . . . ), signifying making a full permutation of EXP1, EXP2, . . . .

6. The grammar compiling method according to claim 1, wherein, on the grammar tree of the semantic meaning, leaf nodes are word categories or referenced external dictionary, non-leaf nodes are operators or function names, and the operands of non-leaf nodes are the contents of respective sub-trees of the non-leaf nodes.

7. The grammar compiling method according to claim 4, wherein, the function &magic (EXP, key, default, display) or the function &magic (EXP, key, default) in the grammar tree of the semantic meaning are marked as non-leaf nodes, and there exist corresponding mapping tables for the function &magic (EXP, key, default, display) or the function &magic (EXP, key, default).

8. The method of claim 1, comprising:
matching a text to be parsed according to a defined sequence onto the grammar tree obtained, wherein if the text to be parsed is completely matched with the grammar tree, it is determined that the corresponding semantic meaning of the grammar tree is the semantic meaning of the text to be parsed.

9. The method according to claim 7, comprising:
matching a text to be parsed according to a defined sequence onto the grammar tree obtained, wherein if the text to be parsed is completely matched with the grammar tree, it is determined that the corresponding semantic meaning of the grammar tree is the semantic meaning of the text to be parsed, wherein, during the matching process, if a section of the text to be parsed is matched with a sub-tree marked by the function &magic (EXP, key, default, display) or the function &magic (EXP, key, default), in the parsing result, the value of the “key” in the corresponding mapping table of the function &magic (EXP, key, default, display) or the function &magic (EXP, key, default) is the section of the text or the value of the “display” in the mapping table.

10. The method of claim 7, comprising:
carrying out a forward maximum matching on a text to be parsed according to a defined sequence onto a grammar tree, wherein, if the text to be parsed has a section that matches a sub-tree marked by a function &magic (EXP, key, default, display) or a function &magic (EXP, key, default) in the grammar tree, it is determined that the corresponding semantic meaning of the grammar tree is the semantic meaning of the text to be parsed.

11. The method according to claim 10, wherein, in the parsing result, the value of the “key” in the corresponding mapping table of the matched function &magic (EXP, key, default, display) or function &magic (EXP, key, default) is the section of the text or the value of “display” in the mapping table.

12. The method according to claim 10, wherein, the corresponding semantic meaning of the grammar tree is determined to be the semantic meaning of the text to be parsed only if a section of the text is matched with a sub-tree of a critical function &magic (EXP, key, default, display) or a critical function &magic (EXP, key, default) defined on the grammar tree.

13. The method of claim 7, wherein the method comprises semantic parsing, by:
S1, matching a text to be parsed onto a grammar tree obtained with the grammar compiling method according to a defined sequence, wherein if the text to be parsed is completely matched with the grammar tree, it is determined that the corresponding semantic meaning of the grammar tree is the semantic meaning of the text to be parsed, otherwise, step S2 is executed;
S2, carrying out a forward maximum matching on the text to be parsed onto the grammar tree according to the defined sequence, wherein, if the text to be parsed has a section that matches a sub-tree marked by a function &magic (EXP, key, default, display) or a function &magic (EXP, key, default) in the grammar tree, it is determined that the corresponding semantic meaning of grammar tree is the semantic meaning of the text to be parsed.

14. The method according to claim 13, wherein in the parsing result, the value of the “key” in the corresponding mapping table of the matched function &magic, (EXP, key, default, display) or function &magic (EXP, key, default) is the section of the text or the value of “display” in the mapping table.

15. A grammar compiling device, comprising:
a file storage unit, used to store a corresponding grammar description file and a corresponding word category description file for a semantic meaning, wherein the grammar description file and the corresponding word category description file are defined based on a logical grammar by manifest language LGML according to a common sentence expression of the semantic meaning, in the grammar description file, the description for a common sentence is composed by operators, word categories, and functions, the word category description file is used to describe specific values for the word categories;
and
a grammar tree generation unit, for respectively generating the grammar description file and the word category file into a grammar tree for the grammar description file and word category trees for the word category file with a reduction method of a defined sequence, and grafting the word category trees to the positions of the corresponding word categories on the grammar tree, forming a grammar tree for the semantic meaning.

16. The grammar compiling device according to claim 15, wherein, the word category description file comprises word items, or comprises, besides word items, at least one of the operators and functions to describe relationships between word items.

17. The grammar compiling device according to claim 15, wherein, the operators include at least one of the following:
an operator +, signifying two or more operands put in series;
an operator |, signifying a parallel relationship between two or more operands;
an operator ( ), indicating operands forming a non-negligible combination;
an operator [ ], indicating operands forming a negligible combination;
an operator ;, indicating the end of a sentence;
an operator :, indicating explanation of a word category in the word category description file; and
an operator “ ”, indicating a reference to an external dictionary.

18. The grammar compiling device according to claim 15, wherein, the functions in the grammar description file include at one of the following:
a function &repeat (EXP, min, max), signifying repeating a grammar portion EXP at least min times, and at most max times;
a function &repeat (EXP, n), signifying repeating EXP n times;
a function &perm (EXP1, EXP2, . . . ), signifying making a full permutation of EXP1, EXP2, . . . ;
a function &grammar (grammar_name), indicating a grammar description file with the name of “grammar_name”; and
a function &magic (EXP, key, default, display) or a function &magic (EXP, key, default), mapping EXP to the semantic tag “the “key””, wherein for the function &magic (EXP, key, default) in a grammar matching process, when EXP is successfully matched with a section T of a text, the “key” has a value of T, otherwise, the “key” has the value of “default”, and for the function &magic (EXP, key, default, display) in the grammar matching process, when EXP is successfully matched with a section T of text, the value of the “key” is the value of “display”, otherwise the “key” has a value of “default”.

19. The grammar compiling device according to claim 16, wherein the functions in a word category description file include at least one of the following:
a function &repeat (EXP, min, max), signifying repeating a grammar portion EXP at least min times, and at most max times;
a function &repeat (EXP, n), signifying repeating EXP n times; and
a function &perm (EXP1, EXP2, . . . ), signifying making a full permutation of EXP1, EXP2, . . . .

20. The grammar compiling device according to claim 15, wherein,
on the grammar tree of the semantic meaning, leaf nodes are word categories or referenced external dictionary, non-leaf nodes are operators or function names, the operands of non-leaf nodes are the contents of respective sub-trees of the non-leaf nodes.

21. The grammar compiling device according to claim 18, wherein,
the function &magic (EXP, key, default, display) and the function &magic (EXP, key, default) are marked as non-leaf nodes, and there are corresponding mapping tables for the function &magic (EXP, key, default, display) and the function &magic (EXP, key, default) in the file storage unit.

22. A semantic parsing device, comprising:
a whole-sentence matching unit, used to parse a text to be parsed according to a defined sequence onto a grammar tree obtained with a grammar compiling device; and
a result determining unit, wherein, if it is determined that the text to be parsed completely matches the grammar tree, the matching result is sent to the result determination unit, and when receiving the matching result, the result determining unit determines that the corresponding semantic meaning of the grammar tree is the semantic meaning of the text to be parsed.

23. The semantic parsing device according to claim 22, wherein, during the matching process, if a section of the text to be parsed is matched with a sub-tree marked by a function &magic (EXP, key, default, display) or a function &magic (EXP, key, default), in the parsing result, the value of the “key” in a corresponding mapping table of the function &magic (EXP, key, default, display) or the function &magic (EXP, key, default) is the section of the text or the value of the “display” in the mapping table.

24. The device of claim 21, comprising:
a semantic mapping matching unit, which, in operation, carries out a forward maximum matching on the text to be parsed according to a defined sequence onto the grammar tree obtained; and
a result determination unit, wherein, if the text to be parsed has a section that matches a sub-tree marked by a function &magic (EXP, key, default, display) or a function &sub-tree magic (EXP, key, default) in the grammar tree, the matching result is sent to the result determination unit and when receiving the matching result, the result determination unit determines that the corresponding semantic meaning of the grammar tree is the semantic meaning of the text to be parsed.

25. The device according to claim 24, wherein in the parsing result obtained by the result determination unit, the value of the “key” in the corresponding mapping table of the function &magic (EXP, key, default, display) or the function &magic (EXP, key, default) is the section of the text or the value of the “display” in the mapping table.

26. The device according to claim 24, wherein, the semantic mapping matching unit sends the matching result to the result determination unit only if there exists a section of the text to be parsed successfully matched with a sub-tree marked by a critical function &magic (EXP, key, default, display) or a critical function &magic (EXP, key, default) defined on the grammar tree.

27. A semantic parsing device, comprising:
a whole-sentence matching unit, used to parse a text to be parsed according to a defined sequence onto a grammar tree obtained with a grammar compiling device;
a semantic mapping matching unit; and
a result determining unit, wherein:
if it is determined that the text to be parsed completely matches the grammar tree, the matching result is sent to the result determination unit, otherwise the semantic mapping matching unit is triggered;
the semantic mapping matching unit, when triggered, carries out a forward maximum matching on the text to be parsed according to the defined sequence onto the grammar tree, if the text to be parsed has a section that matches a sub-tree marked by a function &magic (EXP, key, default, display) or a function &sub-tree magic (EXP, key, default) in the grammar tree, the matching result is sent to the result determination unit; and
the result determining unit, when receiving the matching result, determines that the corresponding semantic meaning of the grammar tree is the semantic meaning of the text to be parsed.

28. The semantic parsing device according to claim 27, wherein, if the result determination unit receives the result from the semantic mapping matching unit, the value of the “key” in the corresponding mapping table of the matched function &magic (EXP, key, default, display) or function &magic (EXP, key, default) is the section of the text or the value of the “display” in the mapping table.

29. A computer storage medium, coded with a computer program, wherein, when executed by one or more computers, the computer program makes the one or more computers execute the following operations:
defining a corresponding grammar description file and a corresponding word category description file based on a logical grammar by manifest language LGML according to a common sentence expression of a semantic meaning, wherein, in the grammar description file, the description for a common sentence is composed by operators, word categories, and functions, the word category description file is used to describe specific values for the word categories;
generating the grammar description file and the word category description file, with a reduction method according to a defined sequence, into a grammar tree for the grammar description file and word category trees for the word category description file;
grafting the word category trees at the positions of corresponding word categories on the grammar tree, forming a grammar tree for the semantic meaning.

30. A computer storage medium, coded with a computer program, wherein, when executed by one or more computers, the computer program makes the one or more computers execute the following operations:
matching a text to be parsed according to a defined sequence onto a grammar tree obtained with a grammar compiling method, wherein, if the text to be parsed is completely matched with the grammar tree, it is determined that the corresponding semantic meaning of the grammar tree is the semantic meaning of the text to be parsed, and the grammar compiling method includes:
defining a corresponding grammar description file and a corresponding word category description file based on a logical grammar by manifest language LGML according to a common sentence expression of a semantic meaning, wherein, in the grammar description file, the description for a common sentence is composed by operators, word categories, and functions, the word category description file is used to describe specific values for the word categories;
generating the grammar description file and the word category description file, with a reduction method according to a defined sequence, into a grammar tree for the grammar description file and word category trees for the word category description file; and
grafting the word category trees at the positions of corresponding word categories on the grammar tree for the grammar description file, forming the grammar tree for the semantic meaning.

31. A computer storage medium, coded with a computer program, wherein, when executed by one or more computers, the computer program makes the one or more computers execute the following operations:
carrying out a forward maximum matching on text to be parsed according to a defined sequence onto a grammar tree obtained with a grammar compiling method, wherein, if the text to be parsed has a section that matches a sub-tree marked by a function &magic (EXP, key, default, display) or a function &magic (EXP, key, default) in the grammar tree, it is determined that the corresponding semantic meaning of the grammar tree is the semantic meaning of the text to be parsed, and the grammar compiling method includes:
defining a corresponding grammar description file and a corresponding word category description file based on a logical grammar by manifest language LGML according to a common sentence expression of a semantic meaning, wherein, in the grammar description file, the description for a common sentence is composed by operators, word categories, and functions, the word category description file is used to describe specific values for the word categories;
generating the grammar description file and the word category description file, with a reduction method according to a defined sequence, into a grammar tree for the grammar description file and word category trees for the word category description file; and
grafting the word category trees at the positions of corresponding word categories on the grammar tree for the grammar description file, forming the grammar tree for the semantic meaning.

32. A computer storage medium, coded with a computer program, wherein, when executed by one or more computers, the computer program makes the one or more computers execute the following operations:
S1, matching a text to be parsed onto a grammar tree obtained with a grammar compiling method according to a defined sequence, wherein if the text to be parsed is completely matched with the grammar tree, it is determined that the corresponding semantic meaning of the grammar tree is the semantic meaning of the text to be parsed, otherwise, step S2 is executed;
S2, carrying out a forward maximum matching on the text to be parsed onto the grammar tree according to the defined sequence, wherein, if the text to be parsed has a section that matches a sub-tree marked by a function &magic (EXP, key, default, display) or a function &magic (EXP, key, default) in the grammar tree, it is determined that the corresponding semantic meaning of grammar tree is the semantic meaning of the text to be parsed, and the grammar compiling method includes:
defining a corresponding grammar description file and a corresponding word category description file based on a logical grammar by manifest language LGML according to a common sentence expression of a semantic meaning, wherein, in the grammar description file, the description for a common sentence is composed by operators, word categories, and functions, the word category description file is used to describe specific values for the word categories;
generating the grammar description file and the word category description file, with a reduction method according to a defined sequence, into a grammar tree for the grammar description file and word category trees for the word category description file; and
grafting the word category trees at the positions of corresponding word categories on the grammar tree for the grammar description file, forming the grammar tree for the semantic meaning.

33. A device, including at least one processor, memory and at least one computer program, which is stored in the memory and executed by the at least one processor, wherein the computer program comprises instructions to execute the following operations:
defining a corresponding grammar description file and a corresponding word category description file based on a logical grammar by manifest language LGML according to a common sentence expression of a semantic meaning, wherein, in the grammar description file, the description for a common sentence is composed by operators, word categories, and functions, the word category description file is used to describe specific values for the word categories;
generating the grammar description file and the word category description file, with a reduction method according to a defined sequence, into a grammar tree for the grammar description file and word category trees for the word category description file; and
grafting the word category trees at the positions of corresponding word categories on the grammar tree, forming a grammar tree for the semantic meaning.

34. A device, including at least one processor, memory and at least one computer program, which is stored in the memory and executed by the at least one processor, wherein the computer program comprises instructions to execute the following operations:
matching a text to be parsed according to a defined sequence onto a grammar tree obtained with a grammar compiling method, wherein, if the text to be parsed is completely matched with the grammar tree, it is determined that the corresponding semantic meaning of the grammar tree is the semantic meaning of the text to be parsed, and the grammar compiling method includes:
defining a corresponding grammar description file and a corresponding word category description file based on a logical grammar by manifest language LGML according to a common sentence expression of a semantic meaning, wherein, in the grammar description file, the description for a common sentence is composed by operators, word categories, and functions, the word category description file is used to describe specific values for the word categories;
generating the grammar description file and the word category description file, with a reduction method according to a defined sequence, into a grammar tree for the grammar description file and word category trees for the word category description file; and
grafting the word category trees at the positions of corresponding word categories on the grammar tree for the grammar description file, forming the grammar tree for the semantic meaning.

35. A device, including at least one processor, memory and at least one computer program, which is stored in the memory and executed by the at least one processor, wherein the computer program comprises instructions to execute the following operations:
carrying out a forward maximum matching on the text to be parsed according to a defined sequence onto a grammar tree obtained with a grammar compiling method, wherein, if the text to be parsed has a section that matches the sub-tree marked by a function &magic (EXP, key, default, display) or a function &magic (EXP, key, default) in the grammar tree, it is determined that the corresponding semantic meaning of the grammar tree is the semantic meaning of the text to be parsed, and the grammar compiling method includes:
defining a corresponding grammar description file and a corresponding word category description file based on a logical grammar by manifest language LGML according to a common sentence expression of a semantic meaning, wherein, in the grammar description file, the description for a common sentence is composed by operators, word categories, and functions, the word category description file is used to describe specific values for the word categories;
generating the grammar description file and the word category description file, with a reduction method according to a defined sequence, into a grammar tree for the grammar description file and word category trees for the word category description file; and
grafting the word category trees at the positions of corresponding word categories on the grammar tree for the grammar description file, forming the grammar tree for the semantic meaning.

36. A device, including at least one processor, memory and at least one computer program, which is stored in the memory and executed by the at least one processor, wherein the computer program comprises instructions to execute the following operations:
S1, matching a text to be parsed onto a grammar tree obtained with a grammar compiling method according to a defined sequence, wherein if the text to be parsed is completely matched with the grammar tree, it is determined that the corresponding semantic meaning of the grammar tree is the semantic meaning of the text to be parsed, otherwise, step S2 is executed;
S2, carrying out a forward maximum matching on the text to be parsed onto the grammar tree according to the defined sequence, wherein, if the text to be parsed has a section that matches a sub-tree marked by a function &magic (EXP, key, default, display) or a function &magic (EXP, key, default) in the grammar tree, it is determined that the corresponding semantic meaning of grammar tree is the semantic meaning of the text to be parsed, and the grammar compiling method includes:
defining a corresponding grammar description file and a corresponding word category description file based on a logical grammar by manifest language LGML according to a common sentence expression of a semantic meaning, wherein, in the grammar description file, the description for a common sentence is composed by operators, word categories, and functions, the word category description file is used to describe specific values for the word categories;
generating the grammar description file and the word category description file, with a reduction method according to a defined sequence, into a grammar tree for the grammar description file and word category trees for the word category description file; and
grafting the word category trees at the positions of corresponding word categories on the grammar tree for the grammar description file, forming the grammar tree for the semantic meaning.
